(19) United States
(12) Patent Application Publication
(10) Pub. No.: US 2008/0305969 A1
(43) Pub. Date: Dec. 11, 2008

(54) Ink Jet Device and Method for Producing a Biological Assay Substrate by Releasing a Plurality of Substances Onto the Substrate

(75) Inventors: Johan Frederik Dijksman, Eindhoven (NL); Anke Pierik, Eindhoven (NL); Antonius Johannes Jo Wismans, Eindhoven (NL); Leonardus Johannes Cornelius Van Den Besselaar, Eindhoven (NL); Martin Maurice Vernhout, Eindhoven (NL); Adrianus Theodorus Anthonius Maria Raaijmakers, Eindhoven (NL); Richard Joseph Marinus Schroeders, Eindhoven (NL); Albert Hendrik Jan Immink, Eindhoven (NL); Roy Gerardus Franciscus Antonius Verbeek, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/095,133

(22) PCT Filed: Nov. 23, 2006
(86) PCT No.: PCT/IB2006/054402

§ 371 Date: May 28, 2008

(30) Foreign Application Priority Data
Nov. 29, 2005 (EP) 05111433.8

(51) Int. Cl. C40B 50/14; C40B 60/14

(52) U.S. Cl. 506/30; 506/40

(57) ABSTRACT

The invention provides an ink jet device (10) for producing a biological assay-substrate by releasing a plurality of substances onto the substrate, the device comprising printing means (20), detection means (30,32,45,45′), filling means and cleaning means (120), and wherein the ink jet device further comprises control means for an automated production such that the production of the biological assay substrate is error tolerant for a multitude of error sources.

The present invention relates to an ink jet device and a method for producing a biological assay substrate by releasing a plurality of substances onto the substrate.

The present invention discloses an ink jet device and a method for producing biological assay substrate by releasing a plurality of substances onto the substrate. Especially for diagnostics, substrates are needed where a plurality of different substances are positioned in a very precise and accurate manner. This plurality of substances are usually to be positioned on a substrate in order perform a multitude of biochemical tests or reactions on the substrate. The ink jet device and the method according to the present invention are preferably applied to the printing process of substances onto a substrate, where the printing process has to be extremely reliable regarding the question, whether a droplet of the substance has been released to the substrate and regarding the question whether a droplet of the substance has been correctly positioned on the substrate. The ink jet device and the method according to the present invention are preferably applied to the printing process of substances onto a substrate, where it is extremely hazardous if a substance of a certain kind is applied wrongly onto a certain region of the substrate. Furthermore, the ink jet device and the method according to the present invention are preferably applied to the printing process of substances onto a substrate, where the printing process has to be extremely reliable regarding the question, whether printing means, especially comprising a print head and a print nozzle, are clean, i.e. are contaminated by a different kind of substance to print onto the substrate.

Ink jet devices are generally known. For example, European patent applications EP 1378359 A1, EP 1378360 A1, EP 1378361 A1 respectively disclose methods of controlling an inkjet print head containing ink where an actuation pulse is applied by an electromechanical transducer in order to eject an ink drop or droplet out of a duct, wherein an electronic circuit is used to measure the impedance of the electromechanical transducer and to adapt the actuation pulse or a subsequent actuation pulse. For example, US-Patent-Application US 2004/0062686 A1 discloses a micro arrayer for spotting solution onto a receiving surface in an automated micro array dispensing device. It is disclosed to perform an analysis of the printing of a substance onto the surface after printing has already been performed. If the printing process has failed, an operator is able to rework the printed spot. One drawback of the known method is that no automated, quality controlled production of biological assay substrates is possible. This strongly limits the reliability of the printing or ink jet device especially for applications where a reliable and automated printing process using a plurality of different substances is essential for an economical production of the biological assay substrates.

It is therefore an objective of the present invention to provide an ink jet device and a method for producing biological assay substrates by releasing a plurality of substances onto the substrates which has a higher degree of reliability and a higher degree of automation while handling a plurality of different printing fluids or substances to print.

The above objective is accomplished by an ink jet device for producing a biological assay substrate by releasing a plurality of substances onto the substrate, the device comprising printing means, detection means, filling means and cleaning means, and wherein the ink jet device further comprises control means for an automated production such that the production of the biological assay substrate is error tolerant for a multitude of error sources.

This has the advantage that a continuous production of a biological assay substrates is possible with a very high reliability regarding the final quality of the substrates. For example, in a preferred embodiment according to the present invention, the ink jet device comprises an automated filling and cleaning station. All print actions are monitored optically and acoustically. Microscopes are mounted equipped with CCD cameras that measure both the volume and the landing position of the droplet and continuously monitor the printing process. At the very moment a droplet is missing or lands outside the predefined landing position, the system stops the printing process, marks the just printed membrane. The system automatically maintains the print head and checks the operation of the print head until and such that it operates according to the specifications again and the printing process can be resumed. Later on the marked membrane will removed out of the amount of membranes printed. Thereby, it is possible to produce a biological assay substrate without any interference by an operator while still producing high quality substrates or membranes. This strongly reduces the production costs of the biological assay substrates.

According to the present invention, it is very much preferred that the detectable error sources comprise a misalignment of the substrate and/or a malfunctioning of the printing means and/or a shortage of substances inside the printing means and/or an error in the kind of the substances. Thereby, a large number of the possible errors can be accounted for by the inventive ink jet device and it is thereby possible to eliminate the substrates, which are printed or produced erroneously.

Very preferably according to the present invention, the printing means comprises at least a print head comprising a nozzle provided to eject a droplet, and wherein the detection means comprises a detection camera arranged such that after ejection of the droplet out of the nozzle, the droplet is detected by the detection camera.

It is preferred according to the present invention that the printing means comprises at least a print head comprising a nozzle provided to eject a droplet, and wherein the detection means comprises at least one alignment camera for aligning the position of the print head relative to the substrate. It is thereby possible to easily and quickly define an initial printing position or starting position for alignment purposes. Preferably, the substrate or the substrate holder (hereinafter also called fixture plate) comprises fiducial marks, i.e. optically visible basing points or basing structures, which are used for alignment of the print head relative to the substrate.

It is preferred according to the present invention that the cleaning means comprises an ultrasonic cleaning apparatus, especially an ultrasonic tooth brush, provided to clean the printing means at least partly. Advantageously, the nozzle and the print head can thereby be cleaned from the outside.

According to the present invention it is further preferred that the cleaning apparatus is provided to cleaning the printing means by applying soft sonic vibrations, especially relatively low frequency ultra sonic vibrations. Thereby, it is possible that the material of the printing means, especially the print head and/or the nozzle, are not too much stressed by the mechanical vibrations applied by the cleaning apparatus. This advantageously extents the lifetime of the printing means.

It is preferred according to the present invention that the substances are discriminable from each other, especially by means of a measurement of the viscosity of the substances. Furthermore it is preferred according to the present invention that the printing means comprises at least a print head comprising a nozzle and a transducer provided to eject a droplet, wherein the detection means are provided such that the substances are discriminable from each other by means of the detection of the behaviour of the transducer. It is advantageous that a multitude of different substances are discriminable by means of a measurement of the behaviour of the transducer and/or of the transducer comprising the substance. The transducer is a—preferably electromechanical—transducer applying mechanical and hydro-acoustical waves into the print head. The print head is preferably an almost closed volume at least partially filled with the liquid to be printed, i.e. the substance to be printed. The print head comprises at least one opening or a duct where upon an actuation pulse at least a part of the liquid contained in the print head can be expelled or ejected forming outside of the print head a droplet of the liquid. In the following, the opening or the duct is also called a nozzle in the context of the present invention. By means of applying mechanical and hydro-acoustical waves into the print head filled with the liquid to print, the system comprising the print head and the liquid is reacting in a different manner if different liquids or substances are used inside the print head. It is advantageous to measure the viscosity of the substances as the measurement of the viscosity is comparably easy and is accessible with a relatively high accuracy. It is furthermore advantageous that the transducer is a piezoelectric transducer because it is possible to use the same transducer for ejecting the droplets and for measuring the behaviour of the fluid inside the print head.

Very preferably, the inkjet device comprises a multi nozzle print head. Thereby, it is possible to eject a plurality of droplets out of one single print head. This speeds up the printing process.

It is preferred according to the present invention that the ink jet device further comprises a print table, a printing bridge, a movable print head holder and a fixture plate, wherein the print head holder is movable relative to the fixture plate in a first, second and third direction (X-direction, Y-direction, Z-direction) by means of three linear stages. Thereby it is possible to print or release droplets of a substance to a large area of application such that the production of printed products can be made quite cost effective because large substrates or individual substrates can be printed as one batch. It is also possible to include reservoirs of the substances to print, reservoirs of cleaning fluid, reservoirs of waste fluid and/or means for mechanically cleaning and drying of the print heads within the cruising range of the print head. Thereby it is possible to further automate the process of producing the biological assay substrate.

According to the present invention it is further preferred that the printing bridge is fixed relative to the print table, wherein the fixture plate is movable relative to the printing bridge in the first and second direction (X-direction, Y-direction), wherein the print head holder is movable relative to the printing bridge in the third direction (Z-direction). This XY-stage embodiment has the advantage that the print head is completely stationary in the first and second direction, so pressure fluctuations caused by moving the substrates under the print head are absent. This means that no vibrations or other possible sources of error can interfere with the printing process.

In another embodiment of the present invention it is preferred that the printing bridge is fixed relative to the print table, wherein the fixture plate is movable relative to the printing bridge in the first direction (X-direction), wherein the print head holder is movable relative to the printing bridge in the second and third direction (Y-direction, Z-direction). This has the advantage that the ink jet device can be arranged using less space.

According to the present invention, it is preferred that the substrate is a flat substrate, a structured substrate or a porous substrate. More preferably, the substrate is a nylon membrane, nitrocellulose, or PVDF substrate, or a coated porous substrate. Because the substrate is preferably porous, the amount of fluid deposited by the droplets into the separate spots (dots) also penetrate into the membrane.

According to the present invention it is further preferred that the substrate comprises a plurality of substrate areas, each substrate area preferably being a separated membrane held by a membrane holder. Thereby, a plurality of separated membranes are possible to be produced by the use of the inventive ink jet device.

Further preferably, the substrate comprises a plurality of substrate locations, the substrate locations being separated from each other at least the average diameter of a spot positioned at one of the substrate locations. Thereby, it is possible to precisely and independently locate different droplets of a substance at precise locations on the substrate. It is also possible and advantageous to place a plurality of droplets on one and the same substrate location.

Very preferably the substance is a volatile solution in liquids like water or alcohols with additional substances to influence the jetting behaviour like glycerol, ethylene glycol, detergents and the like where different molecules or different compounds, especially bio-molecules are present.

The present invention also refers a method for producing a biological assay substrate by releasing a plurality of substances onto the substrate, using an ink jet device comprising printing means, detection means, filling means, cleaning means and control means, wherein an automatic production of the biological assay substrate is performed in a quality controlled manner such that a multitude of different error sources are detected during the production of the substrate. It is thereby possible to produce the biological assay substrate in a very cost effective and automated manner. For example, it is possible to detect every single droplet ejected from the print head (or from the multitude of print heads). If an error occurs, a software module inside the control means conducts the production process such that the respective substrate is marked as defective. A further example is the possibility to detect which one of a plurality of different substances or fluids is inside of the print head. Thereby, it is possible to provide for a higher degree of accuracy of the printing process in the situation where different substances are to be printed in a specified manner.

It is preferred according to the present invention that the detectable error sources comprise a misalignment of the substrate and/or a malfunctioning of the printing means and/or a shortage of substances inside the printing means and/or an error in the kind of the substances. Thereby, a large number of the possible errors can be accounted for by the inventive ink jet device and it is thereby possible to eliminate the substrates which are printed or produced erroneously.

The present invention also refers to a method for producing a biological assay substrate by releasing a plurality of substances onto the substrate, using an ink jet device comprising printing means, detection means, filling means, cleaning means and control means, wherein an automatic production of the biological assay substrate is performed in a quality controlled manner such that a multitude of different error sources are detected before the actual production of the substrate. More in particular it is possible according to the invention to detect the fluid level in the biological and cleaning fluid reservoirs, and/or detect the presence or absence of a cap on the reservoirs before actual printing of the substrate starts. If an error occurs, a software module inside the control means indicates what type of error occurred, and the operator may then correct the error, for instance by removal of the defective reservoir (without a cap) and replacement with a correct reservoir, or by applying a cap onto the defective reservoir. Thereby, it becomes possible to prevent an incorrect printing process from starting.

According to the present invention it is further preferred that the ink jet device comprises at least a print head comprising a nozzle provided to eject a droplet, wherein a malfunctioning of the printing process is detected by the detection means and the associated substrate is marked as failed, wherein the malfunctioning of the printing process results in an incorrect volume of the droplet and/or in an incorrect velocity of the droplet and/or in an incorrect straightness of the flight path of the droplet and/or in an absence of the droplet. It is thereby possible to control precisely the printing process. This makes it possible to assure a very high quality standard in producing the biological assay substrates.

According to the present invention it is further preferred that the cleaning means comprises an ultrasonic cleaning apparatus, especially an ultrasonic tooth brush, provided to clean the printing means at least partly. Advantageously, the nozzle and the print head can thereby be cleaned from the outside.

It is preferred according to the present invention that the cleaning apparatus is provided to cleaning the printing means by applying soft sonic vibrations, especially relatively low frequency ultra sonic vibrations. Thereby, it is possible that the material of the printing means, especially the print head and/or the nozzle, are not too much stressed by the mechanical vibrations applied by the cleaning apparatus. This advantageously extents the lifetime of the printing means.

These and other characteristics, features and advantages of the present invention will become apparent from the following detailed description, taken in conjunction with the accompanying drawings, which illustrate, by way of example, the principles of the invention. The description is given for the sake of example only, without limiting the scope of the invention. The reference figures quoted below refer to the attached drawings.

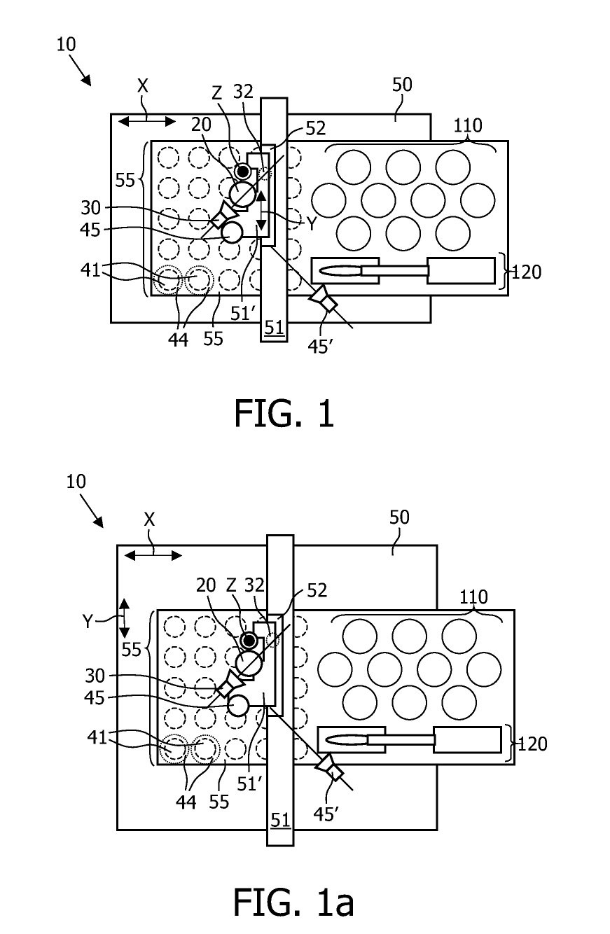

FIGS. 1 and 1a illustrate schematically a top view of two embodiments of the ink jet device of the present invention,

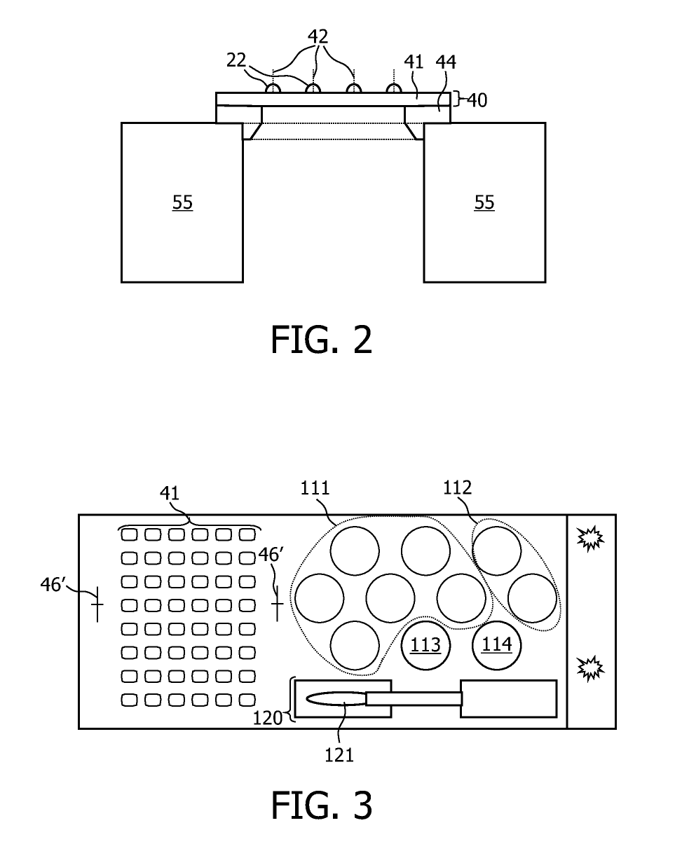

FIG. 2 illustrates schematically a cross section through a substrate area and a membrane holder,

FIG. 3 illustrates schematically a top view of a fixture plate holding membrane holders and a plurality of reservoirs,

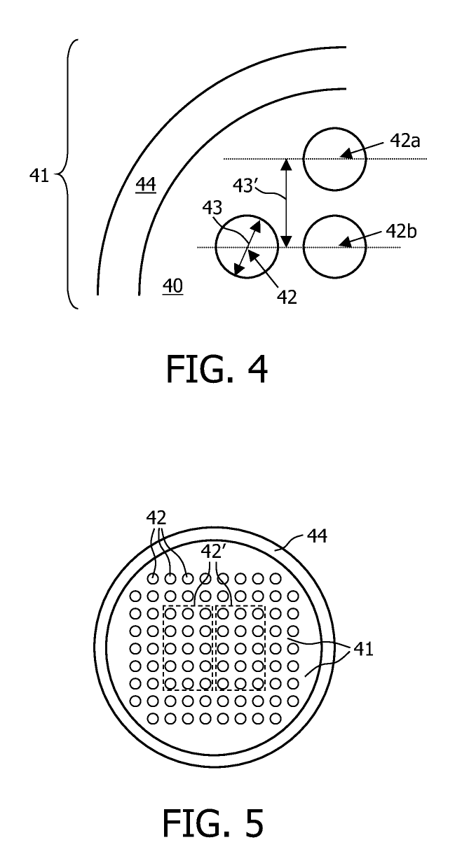

FIGS. 4 and 5 illustrate schematically a part of a substrate area together with a membrane holder and a complete membrane,

FIG. 6 illustrates schematically an embodiment of an ink jet device comprising a plurality of print heads and

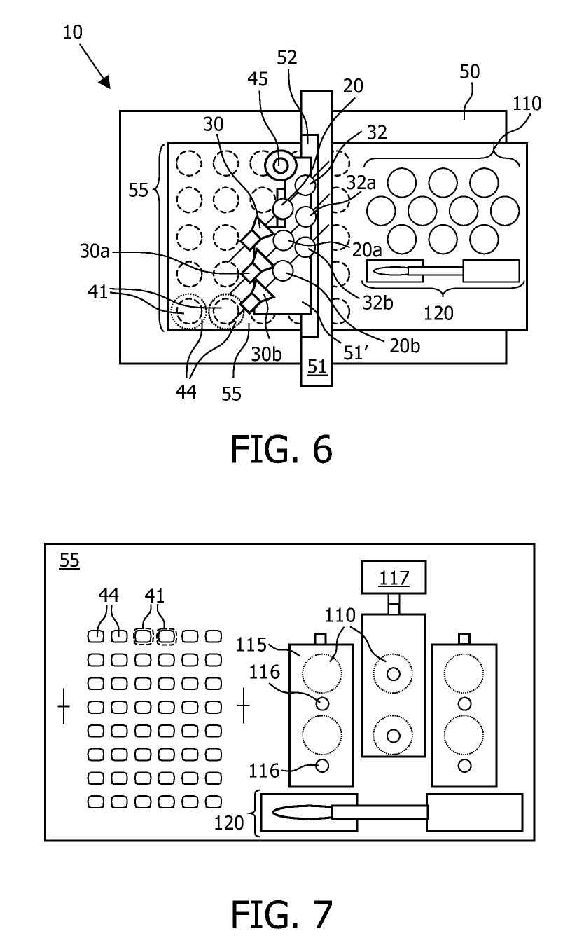

FIG. 7 illustrates schematically a top view of another embodiment of the fixture plate holding membrane holders and a plurality of reservoirs,

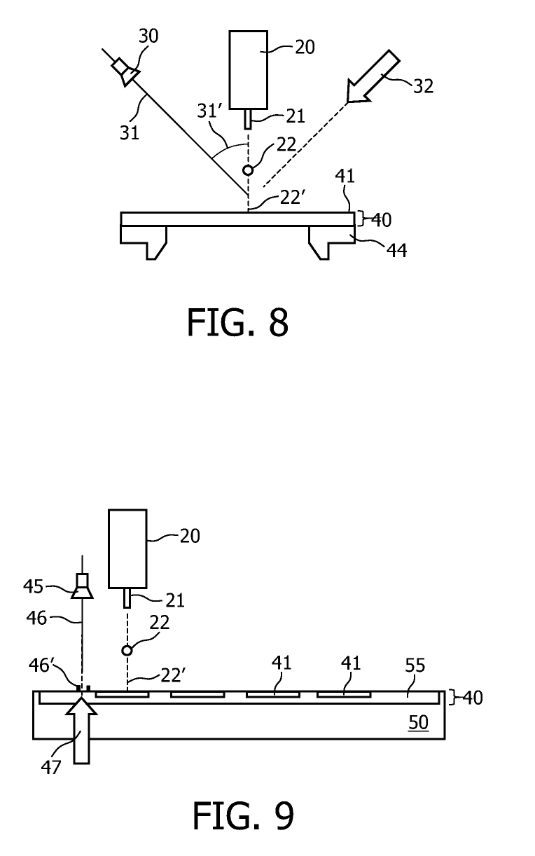

FIG. 8 illustrates schematically a cross section through the print head positioned above a substrate area and a membrane holder together with a detection camera,

FIG. 9 illustrates schematically the positioning of an alignment camera relative to the substrate and the print head,

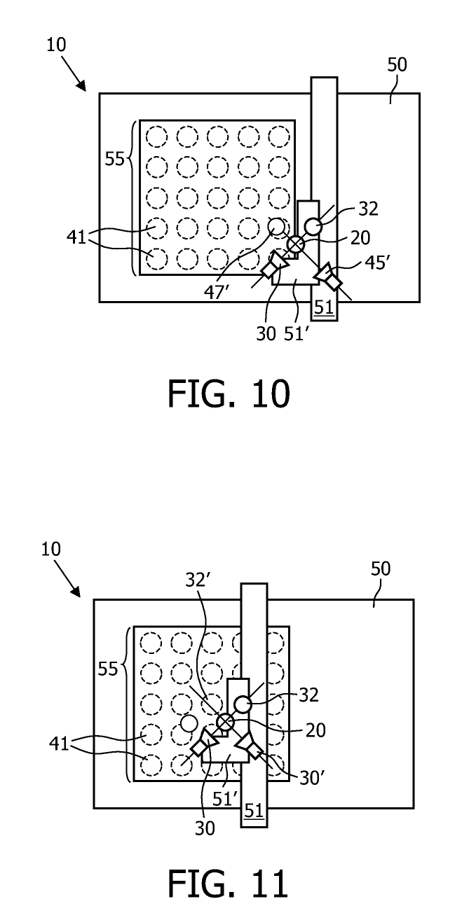

FIG. 10 illustrates schematically the ink jet device positioned in an inspection position,

FIGS. 11 to 13 illustrate schematically an embodiment of the ink jet device with a detection camera and a second detection camera assigned to one print head.

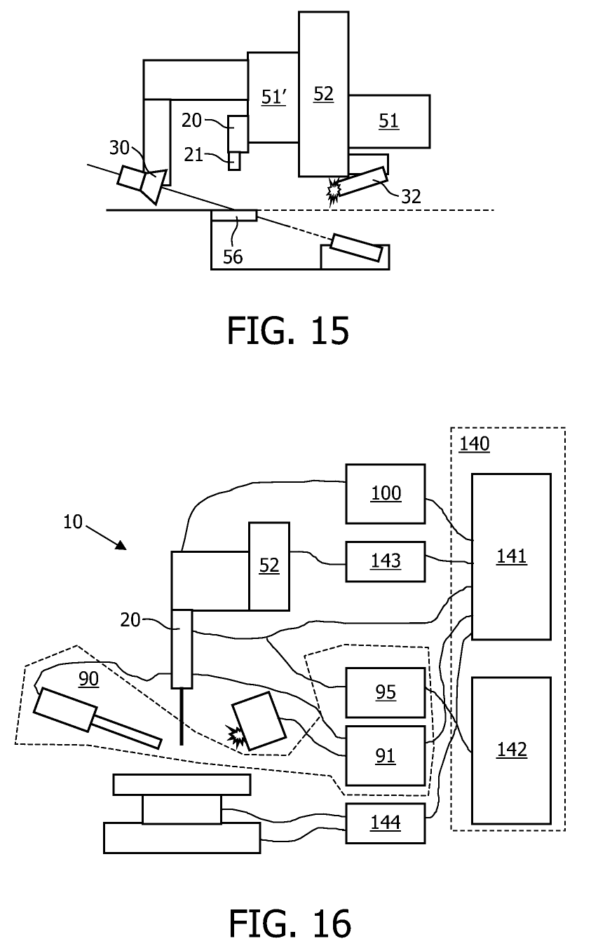

FIGS. 14 and 15 illustrate schematically the arrangement of detection means in order to detect the position, flight path and/or size of droplets ejected from the print head.

FIG. 16 illustrates schematically an overall representation of the ink jet device 10 according to the present invention.

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes.

Where an indefinite or definite article is used when referring to a singular noun, e.g. “a”, “an”, “the”, this includes a plural of that noun unless something else is specifically stated.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described of illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the present description and claims, should not be interpreted as being restricted to the means listed thereafter; it does not exclude other elements or steps. Thus, the scope of the expression “a device comprising means A and B” should not be limited to devices consisting only of components A and B. It means that with respect to the present invention, the only relevant components of the device are A and B.

In FIGS. 1 and 1a, a schematic top view of the ink jet device 10 according to the present invention is shown. On a print table 50 (preferably made of heavy granite plate) a fixture plate 55 is mounted on a linear stage allowing for motions in the X direction of the fixture plate 55. In this fixture plate 55, a number of membrane holders 44 with membranes 41 are positioned. The print table 50 is preferably provided in the form of a granite table. Alternatively, another very heavy material can also be used. According to the present invention, the print table 50 should be arranged in an environment, which has very little vibrational disturbances. The membranes 41 together form the substrate 40. Therefore, the membranes 41 could also be called “substrate 41”. For the sake of clarity, in the following, the term “substrate 40” refers to the totality of the printable area of the “membranes 41”. The membrane holder 44 is basically only a ring 44. A round membrane 41 is welded onto this ring. So, after printing, the ring 44 with spotted membrane 41 together is the final product. A printing bridge 51 is rigidly mounted relative to the print table 50 (preferably a heavy granite table). The printing bridge 51 carries the movable print head holder 51′. The stage with the fixture plate 55 is moveable along a first direction, the X-direction.

In the embodiment shown in FIG. 1, a print head 20 is mounted to the movable print head holder 51′ such that it is moveably along a second direction, the Y-direction, relative to the printing bridge 51.

In a further embodiment shown in FIG. 1a, the fixture plate 55 is mounted on two linear stages allowing for motions in the first direction (X direction) and in the second direction (Y-direction) of the fixture plate 55 relative to the print table 50. In the embodiment shown in FIG. 1a, the print head 20 and the print head holder 51′ is mounted rigidly relative to the printing bridge 51 regarding movements in the first or second direction. In this so called “XY-stage concept” or “XY-stage embodiment”, the print head is completely stationary, so pressure fluctuations caused by moving the print head are absent. Compared to the embodiment shown in FIG. 1, more floor space is needed.

According to the present invention, it is preferred in both embodiments according to FIGS. 1 and 1a, that the first direction (X-direction) and the second direction (Y-direction) are orthogonal. Thereby, the print head 20 can be moved over a certain area of a print table 50 and can release droplets of a substance, which is preferably stored in the print head 20. The membranes 41 are mounted in the fixture plate 55, also called registration plate 55 at uniform distance in X-direction and uniform distance in Y-direction. The distance in X-direction may differ from the distance in Y-direction. According to the present invention, a detection camera 30 is provided, such that a droplet (shown in FIG. 8, item 22) of a substance being ejected from a nozzle of the print head 20 can be detected by the detection camera 30. In a preferred embodiment of the present invention shown in FIG. 1, the detection camera 30 is fixedly positioned near the print head 20 on the movable print head holder 51′. For the detection camera 30 to be able to see the droplet 22, a light source 32 (preferably a stroboscope or controllable flash light) is positioned in an angle to the optical axis of the control camera 30. The light source 32 is preferably mounted fixedly relative to the print head 20 and/or the print head holder 51′.

In order for the print head 20 to be filled with a multitude of different substances, especially fluids comprising bio molecules, the print head holder 51′ is mounted (in both embodiments shown in FIGS. 1 and 1a) on a further linear stage 52 (also called Z-stage) allowing the print head holder 51′ together with the print head 20 to be moved in a third direction, also called Z-direction. The Z-direction is preferably orthogonal relative to the first and second direction, respectively. The Z-stage allows for precise vertical positioning of the print head 20.

Further elements comprising reservoirs 110 and cleaning means 120 are shown in FIGS. 1 and 1a on the fixture plate 55 or connected with the fixture plate 55. The print head 20 can thereby move both over the membranes 41 and over the further elements necessary to perform a complete production of the membranes 41. The basic idea behind the set-up of the ink jet device comprising three different linear stages in three directions is that all positions, like substrate locations 42 or spot positions on the membranes 41 (see FIG. 2), the positions of the fluid containers 110 or fluid reservoirs 110 as well as the height of the fluid levels, the cleaning and drying stations are all given by X,Y,Z values and can all be defined by software. So printing follows a certain protocol, given by the print plan. Filling, purging, cleaning and drying of the inside and the outside of the print head 20 or the pipette 20 can all be defined in protocols and therefore carried out automatically again and again in almost exactly the same way. By doing so, mistakes and handling errors which will be unavoidable if operators would interfere, can be minimised.

The substrate 40 (FIG. 2) may be made of a bio active membrane used for the detection of infectious diseases. Diagnostics of such diseases demands for a very high reliability of the printing process. The read out of the fluorescent pattern relates diseases directly to the positions of the specific capture probes. Therefore, it is absolutely necessary to have a very reliable process for the correct positioning of the capture probes on the substrate 40 as well as for the printing of the correct substance out of a plurality of different substances. Ink jet printing is a precision dosing technique without any feedback about the nature of the actually printed substance and without any feedback about the actual presence and placements of the droplets on the substrate 40. The problem is that there is no information about a course of the process. The present invention aims at gathering as much as possible information about the printing process in view of enhancing the quality of the production of biological assay substrates. According to the present invention, it is possible to measure the viscosity of the substance inside the print head 20 and thereby control and detect a further time, if the substance to be printed is really the right one. In other words the different substances are labelled by their viscosity. Viscosity can be easily tuned or changed by the choice of the solvent or mixture of solvents. Thereby, printing errors can be reduced. According to the present invention, it is also possible to use an optical method to follow instantaneously the printing process of each print head. On the ink jet device 10, two microscopes are mounted equipped with CCD cameras that measure both the landing position of the droplet and continuously monitor the printing process. At the very moment a droplet is missing or lands outside the predefined landing position (FIG. 2, substrate locations 42), the system stops the printing process and marks the just printed membrane 41 or substrate area 41 allowing the system to mark such a substrate or membrane as failed. Later on, the marked membrane can be removed out of the batch of printing the membranes 41.

In the embodiments shown in FIGS. 1 and 1a, an alignment camera 45 is also positioned near the print head 20 and on the print head holder 51′. The alignment camera 45 is positioned at a defined distance from the print head 20. By viewing a certain structure (hereinafter also called fiducial structure) on the fixture plate 55 or on the substrate 40, it is possible to calibrate or to position the print head 20 relative to the print table 50 and therefore relative to the membranes 41.

The alignment camera 45 has two functions: alignment and measuring. An alignment mark (FIG. 3, fiducial mark 46′) is illuminated by a ring of LEDs (not shown) mounted directly on the alignment camera 45. During configuration, the fiducial mark 46′ or alignment marks 46′ are looked for and their positions stored. One fiducial mark 46′ will be used for XY registration, the other for angle correction. The shapes of the alignment marks 46′ are stored as well. Later on, the software will recognise the alignment marks and will position the substrate plate accordingly. The angle correction can be carried out manually or automatically. Regarding measuring, the alignment camera 45 with illumination ring can be used to look for the substrates 40 or the membranes 41 to be printed. Using the same pattern recognition software as for the fiducials 46′ for each membrane 41, its position and rotation with respect to a pre-defined position and direction can be measured and stored. These data will be used later on by the printing software.

An inspection camera 45′ (with an inspection light source 47′) is positioned fixedly relative to the print table 50. By moving the print head 20 to an inspection position, as represented in FIG. 10, the two cameras (detection camera 30 and the inspection camera 45′) are positioned with an angle of 90 degrees respectively to each other. This makes it possible to measure in two dimensions the droplet volume, droplet velocity and droplet flight path. These data can be stored and transferred to the computer controlling the printing program. By correcting for the deviations in the flight path, it can always be assured that the droplet lands on the predetermined position.

The detection camera 30 and the inspection camera 45′ are basically the same and used for the same purpose. The only difference between detection camera 30 and inspection camera 45′ is that detection camera 30 is used during the whole printing process, while inspection camera 45′ is used only during inspection prior to printing. The alignment camera 45 is different as this one is only used before printing a complete batch to align the fixture plate 55 to the print table 50.

In FIG. 11, a further embodiment of the ink jet device 10 is shown. In this embodiment and in contrast to the embodiment shown in FIGS. 1 and 10, a second detection camera 30′ is also (like the detection camera 30) mounted rigidly to the print head. Thereby, a detection of the droplet 22 ejected by the print head 20 is possible in three dimensions. In FIGS. 1 and 10, only during inspection the flight path of the droplets can be recorded in both directions. During printing, only the detection camera 30 records images of droplets 22. In the embodiment as shown in FIG. 11, during inspection as well as during printing, images of droplets 22 in both directions are obtained.

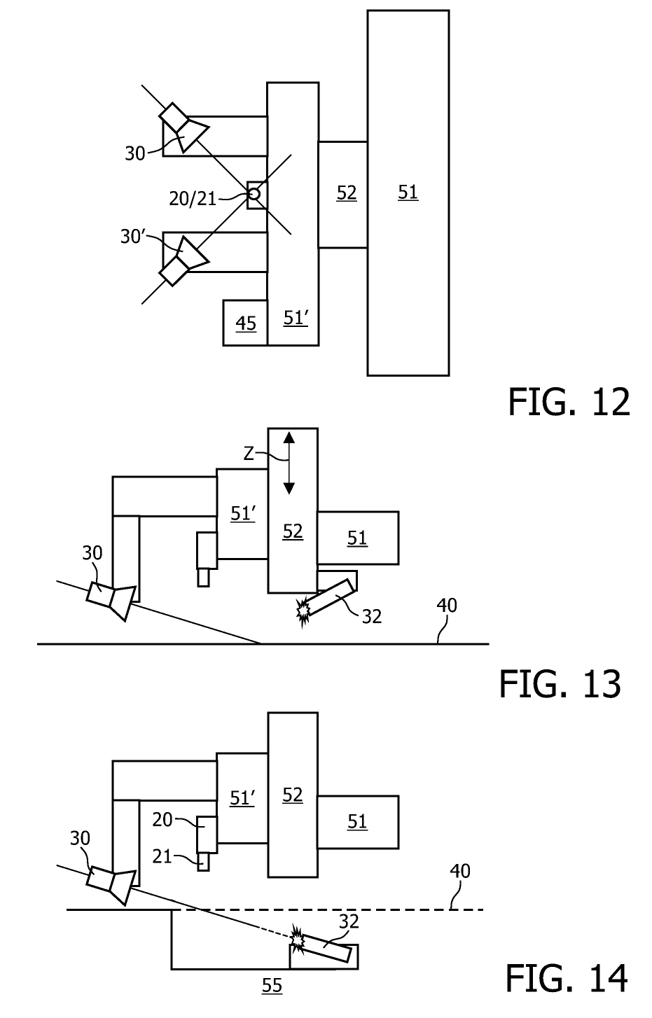

In FIGS. 12, 13 and 14, a part of the inventive ink jet device 10 of the embodiment depicted in FIG. 11 is shown. At the printing bridge 51, the Z-stage 52 is fixed allowing for a vertical movement of the print head holder 51′ along the third direction (Z-direction). At the print head holder 51′, the detection camera 30, the second detection camera 30′ and the alignment camera 45 is mounted. Further, the print head 20 (pipette 20) with the nozzle 21 is mounted at the print head holder 51′. The arrangement of the detection cameras 30, 30′ mounted under 45° to the X-direction an to the Y-direction is chosen to have better access to the print head 20.

In order to detect the droplet emission characteristics, the droplets 22 have to be illuminated properly by the light source 32. Two different ways of illumination are schematically shown in FIGS. 13 and 14. FIG. 13 depicts droplet illumination by diffuse reflection of the stroboscope flash by the substrate surface. This method will be used for following the droplet emission during printing. FIG. 14 shows droplet illumination by stroboscopic flashing in the shadow set-up. The stroboscope is placed on the optical axis of the microscope objective.

The ink jet device 10 is built such that never obstacles associated with droplet measuring and alignment will hit either the substrate 40 or the nozzle 21 or the print head 20. That means that the detection cameras 30, 30′ (microscope objectives for droplet visualisation) have to be mounted under an angle in that way droplets 22 only become visible a certain time after they have left the nozzle 21. The same holds true for the light source 32 or light sources 32′ which are preferably realized as stroboscope or controlled flash units. It should be noted that the detection cameras 30, 30′ (microscope objectives) and the light sources 32, 32′ (stroboscope units) mounted to the print head holder 51′ must leave enough space above the print level (i.e. the level of the substrate 40) to allow the pipette 20 or the print head 20 to dive sufficiently deep into the containers 110 for filling. In FIG. 13, a set-up is schematically drawn where the illumination of the droplets 22 (not shown) takes place by diffuse reflection of the substrate 40. The stroboscope units 32 or light sources 32 are mounted such that the membranes 41 can move freely underneath. In FIG. 14, an arrangement where the light sources 32, 32′ (stroboscopes) are mounted at the edge of the fixture plate 55 below the print level of the substrate 40. The light sources 32, 32′ (stroboscope units) are mounted on the optical axes 31 of the detection cameras 30, 30′ (microscope objectives). This situation is also called “shadow illumination set-up”.

The detection cameras 30, 30′ (also called droplet emission-monitoring cameras) will be used in different modes: Firstly, a droplet position and droplet volume measurement mode where the droplet is recorded by a CCD camera and displayed on a monitor. Image analysis software takes data from the monitor image. The droplet path is measured with respect to an ideal flight path. The volume is measured by taking the area of the droplet. The droplet 22 is illuminated either by a LED stroboscope in streak arrangement (FIG. 13) which means that the droplet is illuminated indirectly by reflection via the substrate or by shadow illumination by a light source 32 (stroboscope) mounted (underneath the substrate level 40) on the optical axis of the detection camera 30 (microscope objective). Secondly, a droplet emission-monitoring mode is possible during printing. Each emitted droplet 22 will be measured. It is not necessary to measure volume; the only thing that counts is if the droplet asked for has indeed passed the field of sight of the detection camera in the right direction. Information of the flight path is also essential in order to avoid misplacement of the droplets. Droplet emission has to be checked up to say 500 Hz. The illumination is always according to the streak set-up (FIG. 13), avoiding any contact with the substrate 40 or membranes 41.

In order to fill the print head 20 or pipette 20, it has to dive in the fluid of the reservoirs 110 a few millimetres. The number of membranes 41 is chosen such that in principle the amount of fluid stored in the pipette 20 is more than enough. Before printing, all containers 110 or reservoirs 110 have to be checked for the right fluid level. In case the fluid level is too low some fluid must be added.

There are a number of ways to check the fluid level automatically, such as:

Two cameras (detection camera 30 and second detection camera 30′, cf. FIG. 11) are mounted for droplet inspection. These detection cameras 30, 30′ can also be used for detection of the moment the tip or nozzle of the print head or pipette touches the surface of the fluid in one of the reservoirs 110. From that position the pipette moves a few millimetres downward and sucks up the amount of fluid needed.

The pipette or print head 20 is provided with a under-pressure control unit (not shown) for keeping the nozzle pressure somewhat below ambient in order to prevent leaking. When the pipette 20 is empty a continuous airflow is present, which can be detected by an airflow indicator (not shown). At the very moment the tip of the pipette touches the fluid in one of the reservoirs 110, the airflow stops because of the much higher viscosity of fluid. This effect is used to detect the Z-distance at which the nozzle 21 of the pipette 20 touches the fluid surface. An extra downward motion of a few millimeters results in the correct dipping depth.

An electrical wire (not shown) is connected to the pipette. In case the fluid is conducting at the moment the nozzle hits the fluid surface an electrical circuit is closed. Upon this signal the pipette moves a few millimeters downwards, before starting filling itself by some extra under pressure.

Parallel to the pipette a laser based distance-measuring device (not shown) is installed that measures the height of the fluid in the container or the reservoir. The software uses this value to calculate the right dipping depth.

Parallel to the pipette an audio based distance-measuring device (not shown) may be installed that measures the height of the fluid in the container or the reservoir. The device sends out an acoustical signal to the fluid surface. The reflected wave is detected and by measuring the time difference (or wavelength shift) for instance, the software is able to calculate the fluid height in the container.

In order to keep the surface of the fluids in the reservoirs 110 at an approximately constant value, the containers 110 or reservoirs 110 can, e.g., be mounted on a spring-like structure. Upon emptying the container the weight decreases and the spring releases such that the fluid level remains at a constant Z-value. Another possibility to achieve a constant surface level of the fluids in the reservoirs 110 is that each container is connected to a larger vessel placed somewhere else, the fluid level in the smaller containers 110 is maintained by communication between the larger vessel and the small container.

One of the above described devices to measure the fluid height in the containers, or a combination thereof, may also be used to detect whether a cap is missing on one or more of the reservoirs. In this way it becomes possible to detect the presence of caps on the reservoirs before the actual printing process actually starts. This gives the user the possibility to correct the error, for instance to replace uncapped reservoirs with the correct reservoirs. It should be noted that checking the presence of a cap on a reservoir may apply to all reservoirs used in the device, and therefore also to the reservoirs containing cleaning fluids. This ensures the cleaning process will be performed correctly. Another preferred option to detect the presence of a cap is to provide the reservoir holder at caps height with a light sensor, and to apply light (preferably uniform) from beneath the reservoir upwards. The rims of the cap are made frosted. In case a cap is present the light is coupled out of the frosted rims and the sensor measures light. In case a cap is missing the light travels upwards through the reservoir and is not detected by the sensor. Still another preferred option is to apply light, for instance laser light, from the side of the reservoir at caps height. A light sensor is positioned on the opposite side. In case a cap is present the light is blocked by it, and the sensor does not detect the light. In case a cap is missing the light travels to the sensor which detects it. If needed, a separate light blocking structure may be attached to the reservoir, for instance when the cap does not rise above the reservoir holder. Still another preferred option is to use an alignment camera, preferably mounted on the print sledge, which is pointed to a marker on the cap.

In FIG. 2, a schematic representation of a cross sectional view of an individual substrate membrane holder 44 and a part of the fixture plate 55 is shown. The membrane holder 44 carries one membrane 41 as a part of the substrate 40. One membrane 41 is also called a substrate area 41. Each individual membrane holder 44 is located on the fixture plate 55. On the substrate 40, i.e. on each membrane 41, a plurality of substrate locations 42 are provided such that an individual dot of a substance (resulting from one or a plurality of droplets printed on that substrate location 42 and schematically illustrated by reference sign 22 in FIG. 2) is able to be located at a distance from one another. A dot can be formed out of one droplet dispensed by the print head or is built-up out of a plurality of droplets of the same substance. Thereby, it is possible to dispense or to position a different kind of substance on each of the substrate locations 42.

In FIG. 3, a top view of a fixture plate holding membrane holders and a plurality of reservoirs is schematically shown. According to the present invention, a plurality of substances 23, 23a, 23b can be filled inside of the print head 20. These different substances 23, 23a, 23b are stored on the fixture plate 55 in substance reservoirs 111. The fixture plate 55 further comprises cleaning reservoirs 112 for one or a plurality of cleaning fluids and waste reservoirs 113 and 114 for depositing waste fluids.

During the printing process, the containers or reservoirs 110 are preferably covered by covers or lids (not shown in FIG. 3), in order to prevent evaporation and cross-contamination. With the fixture plate 55 shown in FIG. 3, it is possible that each container or reservoir 110 has a lid (not shown in FIG. 3) that can be lifted by an electromagnet (not shown in FIG. 3). This electromagnet is mounted to the print head holder 51′. In order to open a container or a reservoir 110 the electromagnet is maneuvered above the container, the magnet is switched on, lifts the lid and holds it. The pipette or print head 20 is moved to the container, dipped and filled. The pipette moves away, the electromagnet returns to the open container, after switching off the lid fall down and closes the container again. In order to ensure the right landing of the lid on the rim of the container, the lower part of the container is shaped such that it automatically readjusts itself to the right position (e.g. conical or spherical). Instead of using an electromagnet, vacuum can be used. A tube that is connected to a vacuum pump by a valve moves to the lid. The valve opens, lifts the lid and keeps it. After filling of the pipette, the tube moves to the open container, the vacuum is switched off and the lid falls down and closes the container.

In FIG. 7, a top view of another embodiment (compared to the embodiment shown in FIG. 3) of the fixture plate 55 holding membrane holders 44 and a plurality of reservoirs 110 is shown. This further embodiment allows for the covering of the fluids in the reservoirs 110 during the printing operation and performs the uncovering action differently than by an electromagnet or by vacuum. The containers 110 are arranged in rows parallel to the Y-direction. On each row there is a lid 115 that closes all the containers 110 of that row. Between the containers 110 the lids 115 have small holes 116. When the pipette 20 or print head 20 (not shown in FIG. 7) needs fluid out of a certain container it is maneuvered to that container. The axis of the openings 116 or holes 116 of the lid 115 preferably matches with the X-position of the print head 20. An uncovering actuator 117, preferably a two position air cylinder, automatically connects with the lid 115 and is able to displace the lid 115 such that the opening 116 corresponding to the container is above the center of that container. The pipette 20 or print head 20 moves to the position of the container needed moves downwards along the third direction (Z-direction) and sucks up the amount of fluid needed. After moving upwards again, the piston of the uncovering actuator 117 moves outwards and closes the containers again. The actuator 117 can be such that only one opening and closing motion is possible, in that case all the containers of the row are opened. With a different actuator 117 that can reach different positions it is possible to design the set-up such that only one container is open at the time.

In FIG. 4, a part of a membrane 41 or a substrate area 41 is shown from the top. On the substrate area 41 are defined a plurality of substrate locations 42, 42a, 42b. The substrate locations 42, 42a, 42b are the locations, where the droplets 22 are to be positioned by the ink jet device 10 according to the present invention. Is it also possible to place a plurality of droplets of the same substance on one single substrate location 42. The droplets 22 which have been ejected by the print head 20 and landed on the substrate 40 will cover a certain dot area or spot around the substrate locations 42, 42a, 42b with an average diameter 43 which is lower than the respective distance 43′ (or pitch) of the substrate locations 42, 42a, 42b from one another.

In FIG. 5 a top view of a substrate area 41 is shown where a plurality of substrate locations 42 are represented by small circles. According to the present invention, many different substances can be positioned on these different substrate locations 42 in order to use the membrane of the substrate area 41 for diagnostic purposes. According to the present invention, it is possible to define several groups 42′ of substrate locations 42 in order to perform a complete set of tests within one group 42′ of substrate locations 42 and their respective substances.

In FIG. 6, a further embodiment of the ink jet device 10 of the present invention is schematically and partly shown. The printing bridge 51 is provided with a further print head 20a and third print head 20b in addition to the print head 20. Accordingly, a further detection camera 30a and third detection camera 30b is positioned near the print heads 20, 20a, 20b. According to the present invention, it is preferable to provide as well a further light source 32a assigned to the further detection camera 30a and a third light source 32b assigned to the third detection camera 30b. In the embodiment according to FIG. 6, up to three or more single nozzle print heads 20, 20a, 20b are arranged on the printing bridge 51. It is either possible that the print heads 20, 20a, 20b move in the second direction (Y-direction) relative to the printing bridge 51 or it is possible that the print heads 20, 20a, 20b are fixed relative to the printing bridge 51 (except the movement in the third direction) and the fixture plate 55 is moved in both the first and the second direction. The print heads 20, 20a, 20b can be moved to any position on the substrate 40 by simultaneously moving the fixture plate 55 (along the X-direction or along the X- and the Y-direction) and/or the print heads 20, 20a, 20b along the Y-direction. In order to minimize the motion of the print head holder 51′ the distances between the print heads 20, 20a, 20b are as close as possible equal to the distance of the membranes 41 in Y-direction. The print heads 20, 20a, 20b can be filled with the same fluid/substance 23, 23a, 23b or each with a different fluid/substance 23, 23a, 23b. By the use of more than one print head 20, a decrease in print time can be obtained when a number of single nozzle print heads are used in parallel.

On a substrate area 41, for example 130 spots or substrate locations 42 can be provided where droplets 22 can be printed, each droplet needing a volume of, e.g., around 1 nl. The diameter 43 of the spots or the droplets 22 is for example 200 μm and they are placed in a pattern with a pitch of, e.g., 400 μm. Of course, it is also possible to provide more (up to 1000) and smaller spots necessitating only a smaller pitch of, for example, 300 μm or only 200 μm, 100 μm or 50 μm. The 130 spots are printed for example with one single print head 20 which is provided with different substances 23. For example, on the fixture plate 55, 140 or up to more than 1000 pieces of membrane holders 44 are arranged which are processed in one batch of printing by the ink jet device 20. The pitch 43′ of the droplet spots is provided in the range of 10 to 500 μm according to the present invention. The diameter 43 of the spots of the droplets 22 is in the range of about 20% to 70% of the actual pitch 43′. The volume of the droplets 22 has to be adapted to the preferred size of the spot and to the material of the substrate 40 used (e.g. dependent of where the substrate strongly or weakly absorbs the substance applied). Typically, the volume of the droplets 22 is about 0.001 nl to 10 nl.

In FIG. 8, a schematic cross sectional representation of the arrangement of the detection camera 30 of the inventive ink jet device 10 is shown. On the membrane holder 44, the membrane 41 or the substrate area 41 is located. The print head 20 comprises the nozzle 21 being able to eject a droplet 22. The droplet 22 moves from the nozzle 21 towards the surface of the substrate 40 on a trajectory 22′ of the droplet 22. During this, the detection camera 30 is able to view an image of the droplet 22 travelling from the nozzle 21 towards the surface of the substrate 40. For the detection camera 30 to be able to see the droplet 22, a light source 32 (preferably a stroboscope or controllable flash light) is positioned in an angle to the optical axis 31 of the detection camera 30. The arrangement of the camera is such that the angle with respect to the surface of the substrate 40 is as small as possible allowing for an as large as possible field of view under the nozzle 21. The same holds true for the optical axis of the stroboscopic illumination system. The droplet 22 is preferably illuminated indirectly be reflection via the substrate 40. The detection camera 30 is fixedly mounted to the print head holder. According to an embodiment of the present invention, the optical axis of the detection camera 30 is inclined by an angle 31′. The light source 32 is preferably mounted fixedly relative to the print head 20.

In FIG. 9, a schematic representation of the alignment step of the print head 20 relative to the membrane 40 or relative to the print table 50 is shown. The alignment camera 45 is positioned (e.g. vertically) such that a structure 46′ (hereinafter also called a fiducial structure 46′) on the print table 50 or on the fixture plate 55 is visible by the alignment camera 45 if the print head 20 and the printing bridge 51 are positioned accordingly. A further source of light 47 is positioned preferably such that the structure 46′ is clearly visible by the alignment camera 45. Therefore, the further light source 47, e.g., is approximately aligned with the optical axis 46 of the calibration camera 45.

In FIG. 15, a schematic representation of a possibility to check the droplet 22 emission while inspecting the nozzle 21 plate (nozzle front) for a multi nozzle print head 20 or a multitude of print heads 20. During the measurement, the fixture plate 55 (or the print head holder 51′) moves in Y-direction. In that way, always a clear mirror surface of a mirror 56 is available. After a scan in Y-direction a next series of measurements is possible after a small displacement in X-direction. The light source 32 (especially a stroboscope) illuminates the droplet 22 by direct reflection. It goes without saying that after measurement the mirror 56 has to be cleaned.

In FIG. 16, a schematic overall representation of the ink jet device 10 according to the present invention is shown. According to the present invention, the ink jet device 10 comprises filling means 100 which produce preferably an under-pressure for filling the print head 20 with the fluid in which it is dipped. In order to avoid cross contamination, the under pressure inside the print head 20 is preferably maintained also during printing. The under-pressure control is performed by a computer, which is part of a control means 140. The under-pressure is also needed to ensure the right pressure levels used for flushing, filling and cleaning.

The functioning of the print head 20 or pipette 20 will be tested acoustically all the time by an acoustic control means 95. The acoustic control means 95 records shifts in measured spectra in both the time and frequency domain in order to check and to ascertain the proper action of the print head 20 (pipette) and the state of filling of the pipettes.

The ink jet device 10 is provided with a control means 140 comprising for example two computers 141, 142. The control means 140 controls of course the X-stage, the Y-stage and the Z-stage by means of a control unit or a plurality of units 143, 144. The detection cameras 30, 30′, the alignment camera 45, the inspection camera 45′, an image analysis unit 91, the acoustic control means 95 and further sensors or detectors form all together the detection means 90. The detection means 90 are provided according to the present invention in order to detect a maximum number of error sources related to the printing process and related to the preparations of the printing process, i.e. for example the filling of the print head 20 with the right substance 23, 23a, 23b.

The control means 140 controls the printing, filling, flushing and cleaning operations. This PC controls:

The under- and over-pressures needed for printing, filling, cleaning and flushing of the print head.

Defining the print programs, fill programs, cleaning programs.

The printing operations like alignment, maneuvering the substrate table to the print, fill and clean positions, setting the print frequency, starting and stopping the print head and moving the print head up and down. The PC also controls all the communication to the XY-stage controller 144 and Z-stage controller 143.

The Single Droplet Nozzle Inspection System for investigation of the droplet emission (volume, speed, satellites, straightness, reliability).

The droplet emission during printing, every droplet will be recorded, as long as the droplets are within the observation window the process goes on.

For the acoustic control, preferably an extra computer 142, e.g. a PC, is used. This computer 142 continuously monitors the acoustic spectrum of the print head (pipette). After each print (a number of droplets on a certain place on a certain substrate) the spectra will be evaluated. Only when all spectra are within a predefined envelope the computer 142 for acoustical testing allows further processing with the production of the substrates 40 or of the membranes 41.

The procedure for printing, filling, flushing and cleaning is foreseen to run according to the following steps:

The membranes 41 are mounted on the substrate holder plate or fixture plate 44.

The containers or reservoirs 110 are filled with the bioactive fluids, a first fluid or substance 23 in a first container of the substance containers 111, a second fluid 23a in a second container of the substance containers 111 and so on. Also the cleaning reservoirs 112 with the flushing and cleaning fluids are filled and the waste containers 113 and 114 for waste are emptied. Each container has a predefined position on the substrate holder plate 55 or fixture plate 55 with respect to the substrate holder plate zero position (one of the alignment marks 46′).

The substrate holder plate 55 is aligned by checking the positions of the fiducials 46′. When needed the rotation is adjusted manually or automatically.

The pipette or print head 20 moves to the centre of the first container.

The Z-stage moves the pipette downwards such that the nozzle dips in the first fluid 23.

By controlling the under-pressure unit 100 or filling means 100, the pipette or print head 20 sucks the first fluid 23 up. Either by timing or by checking the acoustical behaviour of the print head 20, the filling process stops at the moment the pipette is filled.

A droplet counter is set to zero.

The Z-stage 52 moves the micropipette print head 20 upwards to the print Z-position.

The XY-stage moves the substrate holder plate to position (X₀, Y₀).

Droplet emission is tested optically and acoustically and the deviations from the ideal flight paths are determined and entered automatically into the print plan software. By testing the acoustics, the right fluid in the print head (pipette) is tested. When the droplet emission is right, the acoustic spectra are stored and will be used later on as references for checking the action of the print head during printing. All droplets 22 used for droplet formation evaluation are counted. The volume measured is automatically sent to the printer software in order to determine the amount of droplets to be emitted per spot.

The print plan belonging to the first fluid 23 can be carried out.

During printing continuously optically and acoustically the droplet formation will be followed. When deviations become too large the printing will be stopped and the print head 20 will be maintained and tested again. The maintenance protocol will be described later. The membrane 41 where the printing ran out of specifications will be marked and removed after printing and subsequent processing out of the batch.

All droplets ejected are counted. The pipette or print head 20 reservoir contains a certain amount of fluid given in μl. With the Single Droplet Nozzle Inspection System the volume of the droplets has been determined. Consequently the number of droplets contained in the reservoir of the pipette is known and when this amount is used the pipette must be refilled (and the droplet counter set to zero again). At the very moment the pipette gets empty also the acoustical spectra will be change out of specifications.

When the printing of the first fluid 23 is performed, the pipette returns to the first container. The remainder of the first fluid 23 inside the print head 20 will be flushed into the first container.

The pipette 20 moves to the cleaning station or cleaning reservoirs 112 on the substrate holder plate 55. According to the cleaning protocol to be described later on the pipette sucks up cleaning fluids and flushes these into either the waste container 113 or 114. The nozzle front is cleaned with an ultrasonic cleaning apparatus 121, especially an electrical toothbrush, for example a Philips Sonicare electrical toothbrush. At the end, the pipette is blown dry both inside and outside.

The pipette moves to the centre of the second container and the procedure described above will be repeated until the printing of the second fluid 23a is ready and so on.

In case the action of the print head 20 runs out of specifications, it has to be maintained:

The print head 20 moves to the centre of the first fluid 23 reservoir 111.

The remaining amount of the first fluid 23 in the print head 20 is flushed back.

A cleaning procedure is carried out using as a cleaning fluid the solvent of the first fluid 23.

The nozzle front is cleaned with the ultrasonic cleaning apparatus 121, e.g. a Philips Sonicare electrical toothbrush, The print head (pipette) 20 is blown dry both inside and outside.

The print head 20 moves to the centre of the container of the first fluid 23. The print head 20 moves downwards till it dips into the fluid 23 and the first fluid 23 is sucked up again.

The droplet counter is set to zero.

Droplet emission is checked and the relevant data on droplet volume and straightness are transferred automatically to the printer software.

In case the print head (pipette) does not pass the test the complete cleaning procedure has to be carried out. The complete cleaning procedure is similar to a change of fluids.

Changing of fluids from a first fluid 23 to a second fluid 23a will be carried out by the following protocol:

The print head (pipette) moves to the centre of the container of the first fluid 23.

The remaining amount of fluid 23 in the pipette 20 is flushed back into the container.

The print head 20 moves to the centre of a first cleaning fluid container. The Z-stage 52 moves the pipette 20 downwards till the nozzle 21 dips into the first cleaning fluid.

The first cleaning fluid is sucked up. Either timing or acoustical testing controls the extent of filling of the reservoir of the pipette.

The Z-stage lifts the pipette and moves it to the centre of the waste container.

After a short while, giving time for diffusion of contaminations on the inside wall of the pipette, the first cleaning fluid is disposed in the waste container.

This procedure is repeated with a predefined number of cleaning fluids. It depends on the cross-contamination characteristics of the fluids to be inkjet printed after each other how many cleaning steps are needed.

The print head (pipette) moves to the nozzle front cleaning station. The Z-stage lowers the pipette in the cleaning bath.

The nozzle front is cleaned by means of the ultrasonic cleaning apparatus 121, e.g. the Philips Sonicare electrical toothbrush.

The pipette is blown dry both inside and outside.

The pipette moves to the centre of the container with the second fluid 23a and the filling procedure of the second fluid 23a starts.

1. Ink jet device (10) for producing a biological assay substrate (40) by releasing a plurality of substances (23, 23a, 23b) onto the substrate (40), the device (10) comprising printing means (20, 21), detection means (90), filling means (100) and cleaning means (120), and wherein the ink jet device (10) further comprises control means (140) for an automated production such that the production of the biological assay substrate (40) is error tolerant for a multitude of error sources.

2. Ink jet device (10) according to claim 1, wherein the detectable error sources comprise a misalignment of the substrate (40) and/or a malfunctioning of the printing means (20, 21) and/or a shortage of substances (23, 23a, 23b) inside the printing means (20, 21) and/or an error in the kind of the substances (23, 23a, 23b).

3. Ink jet device (10) according to claim 1, wherein the printing means (20, 21) comprises at least a print head (20) comprising a nozzle (21) provided to eject a droplet (22), and wherein the detection means (90) comprises a detection camera (30) arranged such that after ejection of the droplet (22) out of the nozzle (21), the droplet (22) is detected by the detection camera (30).

4. Ink jet device (10) according to claim 1, wherein the printing means (20, 21) comprises at least a print head (20) comprising a nozzle (21) provided to eject a droplet (22), and wherein the detection means (90) comprises at least one alignment camera (45) for aligning the position of the print head (20) relative to the substrate (40).

5. Ink jet device (10) according to claim 1, wherein the cleaning means (120) comprises an ultrasonic cleaning apparatus (121), especially an ultrasonic tooth brush, provided to clean the printing means (20, 21) at least partly.

6. Ink jet device (10) according to claim 5, wherein the cleaning apparatus (121) is provided to cleaning the printing means (20, 21) by applying soft sonic vibrations, especially relatively low frequency ultra sonic vibrations.

7. Ink jet device (10) according to claim 1, wherein the substances (23, 23a, 23b) are discriminable from each other, especially by means of a measurement of the viscosity of the substances (23, 23a, 23b).

8. Ink jet device (10) according to claim 7, wherein the printing means (20, 21) comprises at least a print head (20) comprising a nozzle (21) and a transducer provided to eject a droplet (22), wherein the detection means (90) are provided such that the substances (23, 23a, 23b) are discriminable from each other by means of the detection of the behaviour of the transducer.

9. Ink jet device according to claim 1 wherein the inkjet device (10) comprises a multi nozzle print head (20).

10. Ink jet device (10) according to claim 1, wherein the ink jet device (10) further comprises a print table (50), a printing bridge (51), a print head holder (51′) and a fixture plate (55), wherein the print head holder (51′) is movable relative to the fixture plate (55) in a first, second and third direction (X-direction, Y-direction, Z-direction) by means of three linear stages.

11. Ink jet device (10) according to claim 10, wherein the printing bridge (51) is fixed relative to the print table (50), wherein the fixture plate (55) is movable relative to the printing bridge (51) in the first and second direction (X-direction, Y-direction), wherein the print head holder (51′) is movable relative to the printing bridge (51) in the third direction (Z-direction).

12. Ink jet device (10) according to claim 10, wherein the printing bridge (51) is fixed relative to the print table (50), wherein the fixture plate (55) is movable relative to the printing bridge (51) in the first direction (X-direction), wherein the print head holder (51′) is movable relative to the printing bridge (51) in the second and third direction (Y-direction, Z-direction).

13. Ink jet device (10) according to claim 10, wherein the first direction (X-direction), the second direction (Y-direction) and the third direction (Z-direction) are mutually orthogonal.

14. Ink jet device (10) according to claim 1, wherein the substrate (40) is a flat substrate, a structured substrate, a coated substrate or a porous membrane (41), preferably a nylon membrane.

15. Ink jet device (10) according to claim 1, wherein the substrate (40) comprises a plurality of substrate areas (41), each substrate area (41) preferably being a separated membrane (41) held by a membrane holder (44).

16. Ink jet device (10) according to claim 1, wherein the substrate (40) comprises a plurality of substrate locations (42, 42a, 42b), the substrate locations (42, 42a, 42b) being separated from each other by at least the average diameter (43) of a droplet (22) positioned at one of the substrate locations (42, 42a, 42b).

17. Ink jet device (10) according to claim 1, wherein a plurality of droplets (22) are superposed on one substrate location (42, 42a, 42b).

18. Method for producing a biological assay substrate (40) by releasing a plurality of substances (23, 23a, 23b) onto the substrate (40), using an ink jet device (10) comprising printing means (20, 21), detection means (90), filling means (100), cleaning means (120) and control means (140), wherein an automatic production of the biological assay substrate (40) is performed in a quality controlled manner such that a multitude of different error sources are detected during the production of the substrate (40).

19. Method according to claim 18, wherein the detectable error sources comprise a misalignment of the substrate (40) and/or a malfunctioning of the printing means (20, 21) and/or a shortage of substances (23, 23a, 23b) inside the printing means (20, 21) and/or an error in the kind of the substances (23, 23a, 23b).

20. Method according to claim 18, wherein the ink jet device (10) comprises at least a print head (20) comprising a nozzle (21) provided to eject a droplet (22), wherein a malfunctioning of the printing process is detected by the detection means (90) and the associated substrate (40) is marked as failed, wherein the malfunctioning of the printing process results in an incorrect volume of the droplet (22) and/or in an incorrect velocity of the droplet (22) and/or in an incorrect straightness of the flight path of the droplet (22) and/or in an absence of the droplet (22) and/or the wrong substance.

21. Method according to claim 18, wherein the cleaning means (120) comprises an ultrasonic cleaning apparatus (121), especially an ultrasonic tooth brush, provided to clean the printing means (20, 21) at least partly.

22. Method according to claim 21, wherein the cleaning apparatus (121) is provided to cleaning the printing means (20, 21) by applying soft sonic vibrations, especially relatively low frequency ultra sonic vibrations.
